(19) United States
(12) Patent Application Publication
(10) Pub. No.: US 2012/0110493 A1
(43) Pub. Date: May 3, 2012

(54) TEXT ENTRY USING A STEERING WHEEL IN A VEHICLE

(75) Inventor: Cesar Cabral, Los Angles, CA (US)

(73) Assignee: HONDA MOTOR CO., LTD., Tokyo (JP)

(21) Appl. No.: 12/913,458

(22) Filed: Oct. 27, 2010

(51) Int. Cl. G06F 3/048

(52) U.S. Cl. 715/773

(57) ABSTRACT

The present invention describes an in-vehicle text entry method and system using controls of a steering wheel. The in-vehicle text input system provides a graphical user interface (GUI) keyboard layout that is conducive to memorization.

### FIELD OF THE INVENTION

The present invention relates generally to a text entry method, and more particularly to text entry in a vehicle using a steering wheel of the vehicle.

### BACKGROUND OF THE INVENTION

In conventional in-vehicle text input systems, the method in which to enter text requires the driver to look at a display screen to select an appropriate character to type. Generally, the QWERTY layout of characters in conventional in-vehicle text input systems is non-intuitive. Thus, even with enough text input practice, it is almost impossible to input a string of characters in conventional in-vehicle text input systems without the driver taking his or her eyes off the road to look at a QWERTY keyboard of the vehicle. The driver must divert his or her attention from the road in order to view the display screen for character selection.

Furthermore, many conventional in-vehicle text input systems utilize touch screen displays to enter text in the vehicle. Thus, not only does the driver focus his or her attention on the display screen rather than on the road, the driver must also use one of his or her hand's to input text via the touch screen display.

### SUMMARY OF THE INVENTION

The present invention describes an in-vehicle text entry method and system using controls of a steering wheel. The driver may use the in-vehicle text input system to input text for driving directions, for electronic mail (e-mail), text messages, or any other situations in which the driver may want to enter text.

In the present invention, the in-vehicle text input system provides a graphical user interface (GUI) keyboard layout that is conducive to memorization. Thus, the keyboard layout of the present invention aids in the driver's memorization of character placement in the keyboard. Because the keyboard layout of the present invention is intuitive, text entry during vehicle operation does not distract the driver from driving the vehicle.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 illustrates an in-vehicle text input system according to one embodiment of the present invention.

FIG. 2 illustrates text input controls mounted on a steering wheel of a vehicle according to one embodiment of the present invention.

FIG. 3 illustrates cursor movement on a display screen of the vehicle using the text input controls according to one embodiment of the present invention.

FIG. 4 illustrates a graphical user interface of a main keyboard used in the in-vehicle text input system according to one embodiment of the present invention.

FIG. 5 illustrates operation of the main keyboard used in the in-vehicle text input system according to one embodiment of the present invention.

FIG. 6 illustrates operation of sub-menu keyboards to select symbols, numbers, or punctuation according to one embodiment of the present invention.

FIG. 7 illustrates a graphical user interface for editing inputted text according to one embodiment of the present invention.

FIG. 8 illustrates a graphical user interface for providing automatic suggestions to complete text according to one embodiment.

FIG. 9 illustrates a method for entering text in the in-vehicle text input system according to one embodiment of the present invention.

FIG. 10 illustrates a graphical user interface of the in-vehicle text input system during vehicle movement according to one embodiment of the present invention.

FIG. 11 illustrates an alternative graphical user interface of the main keyboard used in the in-vehicle text input system according to one embodiment of the present invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE INVENTION

A preferred embodiment of the present invention is now described with reference to the figures where like reference numbers indicate identical or functionally similar elements. Also in the figures, the left most digits of each reference number corresponds to the figure in which the reference number is first used.

Reference in the specification to “one embodiment” or to “an embodiment” means that a particular feature, structure, or characteristic described in connection with the embodiments is included in at least one embodiment of the invention. The appearances of the phrase “in one embodiment” or “an embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems. The invention can also be in a computer program product which can be executed on a computing system.

The present invention also relates to an apparatus for performing the operations herein. This apparatus may be specially constructed for the purposes, e.g., a specific computer, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

### System Overview

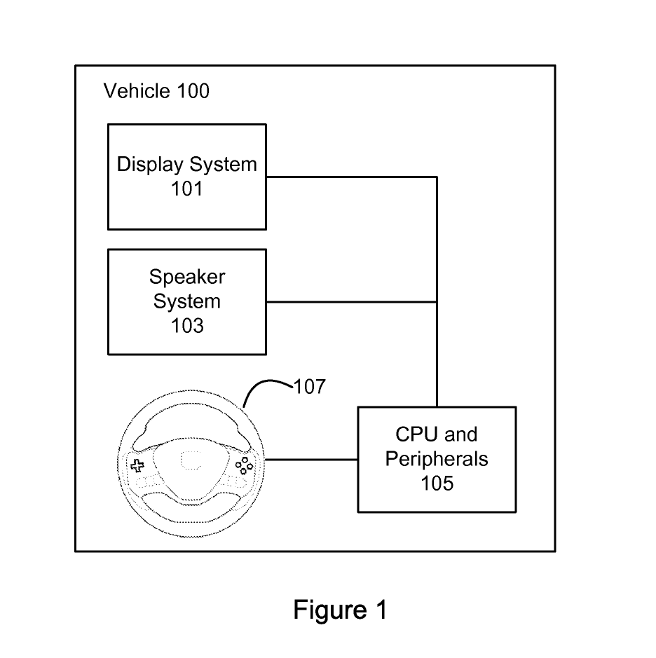

Referring now to FIG. 1, there is shown one embodiment of an in-vehicle text input system used for entering text during vehicle operation. The driver may utilize the in-vehicle text input system to input text for driving directions, for electronic mail (e-mail), text messages, or any other situations in which the driver may want to enter text within a vehicle.

In one embodiment, the in-vehicle text input system provides a graphical user interface (GUI) keyboard layout that is conducive to memorization. The intuitive keyboard layout of the present invention aids in memorization of character placement. Furthermore, text entry via the steering wheel of the vehicle allows the driver to keep both hands on the steering wheel while entering text.

In one embodiment, a vehicle 100 comprises a display system 101, a speaker system 103, a computer processing unit (CPU) and peripherals 105 and a steering wheel 107. In other embodiments, the vehicle 100 may include components other than those illustrated in FIG. 1. Note that in the present invention, the vehicle is described as an automobile, but may also include aircraft, watercraft, or any other types of transportation means that requires text input during vehicle operation.

The display system 101 represents any device equipped to visually display electronic images such as a GUI keyboard layout as described herein. The display system 101 displays to a driver (i.e., a user) of vehicle 100 the keyboard and strings of inputted alphanumeric characters and symbols. The display system 101 may comprise, for example, an organic light emitting diode display (OLED), liquid crystal display (LCD), cathode ray tube (CRT) display, or any other similarly equipped display device, screen or monitor. The display system 101 may be implemented in a heads up display, navigation system display, or any display system within the vehicle 100.

The speaker system 103 represents the speaker head unit, speakers, and/or amplifiers used to output audio in the vehicle 100. The speaker system 103 outputs audio from various sources such as radio stations, compact disk, cassette, or MP3. In addition, the speaker system 103 outputs audio cues (i.e., sounds) corresponding to characters or words selected from the keyboard during text entry in the vehicle 100.

Generally, the speaker system 103 outputs an audio cue corresponding to a selected character. By outputting the audio cue, the in-vehicle text input system of the present invention verbally confirms to the driver that the correct character was selected during text input. As described above, during vehicle operation it is preferable that the driver maintain both eyes on the road rather than look at a display system 101 during text input. Thus, the driver may not want to visually confirm via the display system 101 that the correct character was selected during text input. By having the speaker system 103 output an audio cue corresponding to the selected character, the driver is reaffirmed that the correct character was selected. For example, responsive to the driver selecting the character “e”, the speaker system 103 outputs an audio cue corresponding to the pronunciation of the character “e.” The driver may continue entering additional text if “e” was the character intended for selection or the driver may erase (i.e., delete) the character and input the correct character.

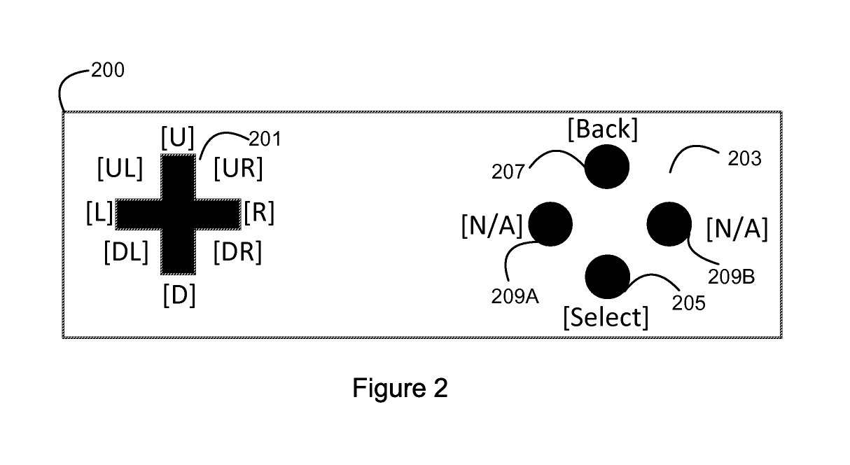

In one embodiment, the steering wheel 107 of the vehicle 100 is used by the driver to input text while operating vehicle 100. The steering wheel 107 comprises controls used by the driver to input the text. Referring now to FIG. 2, there is shown one embodiment of the controls 200 of the steering wheel 107 used for in-vehicle text input. The controls 200 comprise a directional pad 201 and buttons 203. In one embodiment, the directional pad 201 is mounted on the left side of the steering wheel 107 and the buttons are mounted on the right side of the steering wheel 107. However, in alternative embodiments the controls 200 may be placed at different locations of the steering wheel 107 other than those shown herein.

The directional pad 201 is used by the driver of vehicle 100 to control the movement of a cursor of the keyboard that is displayed on the display system 101. The cursor is used to select user interface elements (e.g., buttons) of the keyboard for character input. The directional pad 201 may move the cursor in the following eight directions:
up [U];
up-right [UR];
right [R];
down-right [DR];
down [D];
down-left [DL];
left [L]; and
up-left [UL].

To select the up, down, left, or right direction, the driver presses the directional pad 201 in the corresponding direction. To select the up-right direction, the driver substantially simultaneously selects the up and right directions of the directional pad 201. Similarly, to select the down-right direction, the driver substantially simultaneously selects the down and right directions of the directional pad 201. To select the down-left direction, the driver substantially simultaneously selects the down and left directions of the directional pad 201. To select the up-left direction, the driver substantially simultaneously selects the up and left directions of the directional pad 201. Note that in alternative embodiments, a directional ball or circular/elliptical shaped pad may also be used to control the cursor rather than the directional pad illustrated in FIG. 2.

In one embodiment, buttons 203 may include a select button 205 and a back button 207. The select button 205 on the steering wheel 107 is used by the driver to select various buttons included in the keyboard, as will be described in further detail below. In an alternative embodiment, the select button may be integrated into the directional pad 201. In the alternative embodiment, the select button may be activated by the driver pressing the center of the directional pad 201. The back button 207 allows the driver of the vehicle 100 to go back to any previous menu that the user was previously viewing. The buttons 203 may also include one or more buttons that initially lack any functionality. With respect to FIG. 2, the non-functional buttons correspond to the buttons 209 indicated as “N/A.” However, the driver of vehicle 100 may program the N/A buttons 209 to perform specific functionality.

For example, N/A button 209A may be programmed by the driver to perform a “backspace” operation thereby deleting a character upon selection of the button. In another example, N/A button 209B may be programmed by the driver to perform the “space” operation responsive to selection of the button. Note that any functionality may be attributed to the N/A buttons 209 that are in the scope of the present invention described herein.

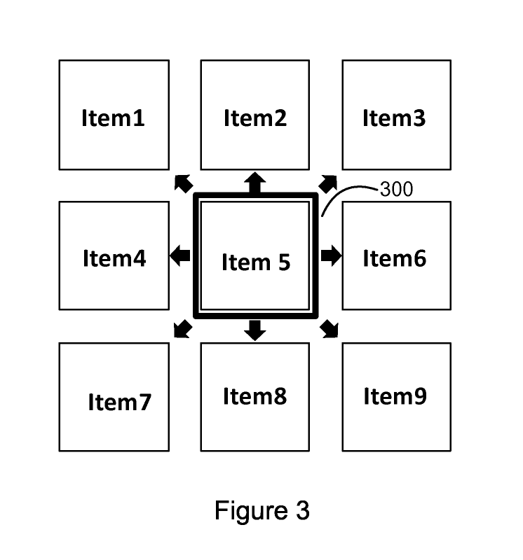

Referring now to FIG. 3, there is shown an example user interface for controlling a cursor 300 of a keyboard using controls 200. As shown in FIG. 3, the user interface comprises a set of items comprising items 1 through 9. Generally, in one embodiment the default position of cursor 300 is the center of a set of user interface elements. That is, the cursor 300 initially highlights the item located in the center of the set. In this example, the cursor 300′s default position is item 5. To move the cursor to item 1, the driver substantially simultaneously presses the up-left directions on the directional pad 201 to move cursor 300 to item 1. To move the cursor to item 2, the driver presses the up direction on the directional pad 201 to move cursor 300 to item 2. To move the cursor to item 3, the driver substantially simultaneously presses the up-right directions on the directional pad 201 to move cursor 300 to item 3. To move the cursor to item 4, the driver presses the left direction on the directional pad 201 to move cursor 300 to item 4. Because the cursor 300 is initialized on the center item (e.g., item 5), the driver need not move the cursor to reach item 5. To move the cursor to item 6, the driver presses the right direction on the directional pad 201 to move cursor 300 to item 6. To move the cursor to item 7, the driver substantially simultaneously presses the left-down directions on the directional pad 201 to move cursor 300 to item 7. To move the cursor to item 8, the driver presses the down direction on the directional pad 201 to move cursor 300 to item 8. Finally, to move the cursor to item 9, the driver substantially simultaneously presses the down-right direction on the directional pad 201 to move cursor 300 to item 9.

Referring back to FIG. 1, vehicle 100 further comprises CPU and peripherals 105. In one embodiment, the peripherals may include memory that stores instructions and/or data that may be executed by the CPU. The instructions and/or data may comprise code for performing any and/or all of the techniques described herein. For example, the memory may include code for generating the keyboard layout or text input method described herein. Memory may be a dynamic random access memory (DRAM) device, a static random access memory (SRAM) device, Flash RAM (non-volatile storage), combinations of the above, or some other memory device known in the art.

The CPU processes data signals and may comprise various computing architectures including a complex instruction set computer (CISC) architecture, a reduced instruction set computer (RISC) architecture, or an architecture implementing a combination of instruction sets. Although only a CPU is shown in FIG. 1, multiple CPUs may be included. The CPU comprises an arithmetic logic unit, a microprocessor, a general purpose computer, or some other information appliance equipped to transmit, receive and process electronic data signals from the memory.

### Keyboard Elements

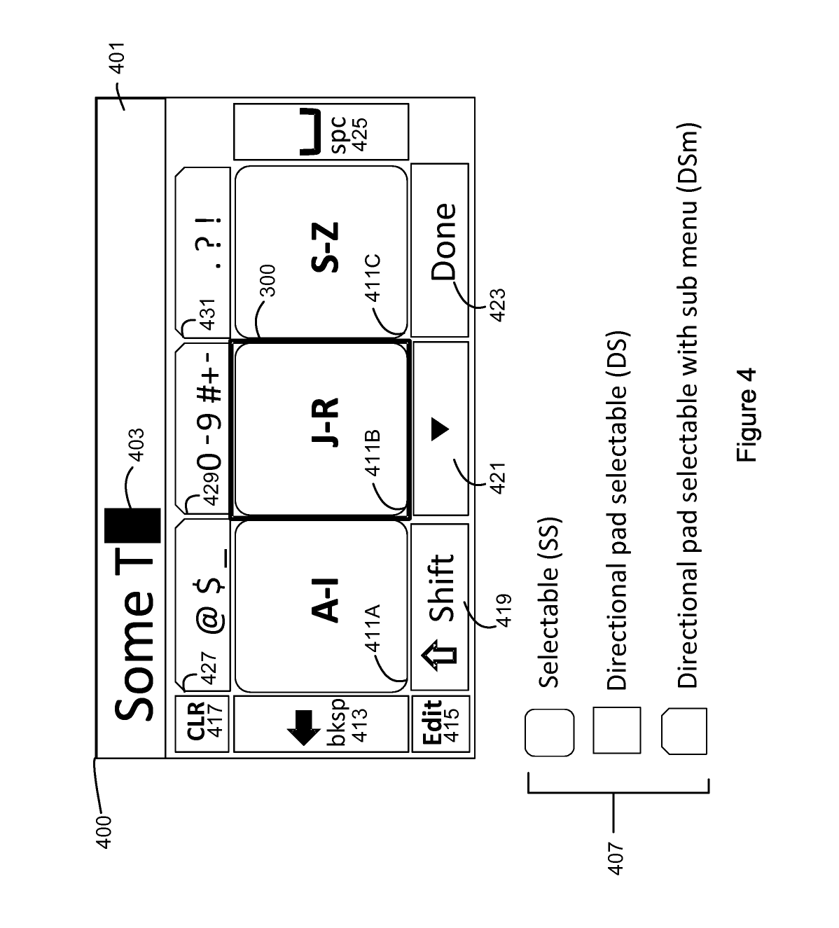

Referring now to FIG. 4, there is shown one embodiment of an onscreen keyboard 400 displayed on the display system 101 of vehicle 100 for in-vehicle text input. The keyboard 400 illustrated in FIG. 4 illustrates the main keyboard of the in-vehicle text input system. As described previously, the keyboard 400 may be used to enter text into a navigation system of the vehicle 100, for entering text into an email application of the vehicle 100, or for entering text into a text message application of the vehicle 100 that is synced to a mobile phone of the driver. Note that the keyboard 400 may be used for any other activities that require text entry while in a vehicle other than those described herein.

In one embodiment, the keyboard 400 comprises a text field 401. The text field 401 displays text selected by the driver of the vehicle 100. The keyboard 400 also comprises a text cursor 403 displayed within the text field 401. The text cursor 403 indicates where the next character will be typed in the text field 401. Furthermore, the keyboard 400 comprises cursor 300 previously described above. The cursor 300 indicates which button on the keyboard 400 is currently in context. That is, the cursor 300 indicates to the driver which button is currently highlighted for selection. In one embodiment, the default position of the cursor 300 is the center of keyboard 400 (e.g., button 411B) as will be described in further detail below.

In one embodiment, the keyboard 400 comprises three types of selectable buttons 407 or user interface elements. The different types of buttons 407 are visually distinguished from one another on the keyboard 400. Thus, each type of button comprises a different visual appearance on the keyboard 400. Furthermore, how the driver selects each button is based on the button type.

In one embodiment, keyboard 400 comprises selectable (SS) buttons. SS buttons are represented in the keyboard 400 as square buttons with chamfered or rounded edges. For example, character set buttons (user interface elements) 411 are SS buttons. The character set buttons 411 collectively comprise the letters of the alphabet. Each individual character set button comprises a distinct set of characters from the alphabet.

The first or left most character set button 411A comprises letters A through I of the alphabet. The second or center character set button 411B comprises letters J through R of the alphabet. The third or right most character set button 411 C comprises letters S through Z. Selection of a character set button 411 causes the button to display the characters associated with the button, as will be described in further detail below. Furthermore, in one embodiment, selection of a character set button 411 causes speaker system 103 to provide an audio cue corresponding to the selection. For example, if character set button 411A is selected, the speaker system 103 provides the audio cue stating “A through I.” Thus, the audio cue indicates to the driver that the selected button comprises the letters in the alphabet from A through I.

In one embodiment, SS buttons are selected by the driver pressing and releasing the select button 205 on the steering wheel 107. The driver of the vehicle uses the directional pad 201 in combination with the select button 205 to select a SS button. Consider an example where the driver wants to select character set 411A. From the default position of cursor 300, the driver of the vehicle presses the left direction on the directional pad 201 on the steering wheel 107 to move cursor 300 to character set 411A. The driver then presses and releases the select button 205 on the steering wheel 107 to select character set 411A.

Keyboard 400 also comprises directional pad selectable (DS) buttons. DS buttons are represented in the keyboard 400 by square buttons. The following buttons are examples of DS buttons in keyboard 400 and their associated functionality:
Clear (CLR) button 417: a keyboard action button that clears all the text within the text field 401;
Backspace (BKSP) button 417: a keyboard action button that deletes the character directly preceding the text cursor 403 in the text field 401;
Edit button 415: a keyboard action button that allows the driver to edit the text in the text field 401 as will be described in further detail below;
Shift button 419: a keyboard action button that used in combination with a character button (that will be described in detail below) to create an upper case character of the selected character button;
Down arrow button 421: a keyboard action button that allows the driver to select auto-suggestions to complete text entered into text field 401 as will be described in further detail below;
Done button 423: a keyboard action button that confirms that text entry is complete; and
Space (SPC) button 425: a keyboard action button that adds a space between text characters in text field 401.

In one embodiment, DS buttons are selected by the driver by pressing and releasing the directional pad 201 on the steering wheel 107 in a direction that corresponds to the button with respect to the current cursor 504 location. The button is not selected until the driver releases the directional pad completely. That is, the button is not selected until none of the eight directions in the directional pad are engaged. The select button 205 is not used to select a DS button. For example, the driver may wish to select a keyboard action button such as the backspace button 413. Assuming that the cursor 300 is at the default position (e.g., at button 411B), the driver presses the directional pad 201 on steering wheel 107 in the sequence left-left. The first left direction moves the cursor 300 over button 411A. However, since button 411A is not a DS button, the button is not selected. The second left direction selection causes the cursor 300 to move to the position of the backspace button 413. Once the directional pad 201 is released, the backspace button 413 is selected since it is a DS button.

By waiting until the directional pad is disengaged to select a DS button, the driver may roll (i.e. press) the directional pad 201 through all eight directions to move the cursor 300 around the keyboard 400. Thus, the driver may browse all the surrounding possible buttons for selections before making a decision to select a button. For example, the driver may want to select the done button 423. The driver may select the done button 423 by simply pressing the down-right directions simultaneously to select the done button 423. However, the driver may also roll the directional pad to select the done button 423. To roll the directional pad 201 to select the done button 423, the driver presses the down button and while the down button is still engaged presses the right button to move the cursor 300 to the done button 423. Once the directional pad 201 is disengaged, the done button 423 is selected.

Keyboard 400 also comprises directional pad selectable buttons with a sub-menu (DSm). DSm buttons are represented in the keyboard 400 by square buttons with rounded top corners. The following buttons are examples of DSm buttons in keyboard 400:
Symbol button 427: activates (i.e., opens) a sub-menu that comprises various symbols such as the “$” symbol, “@” symbol, and “\” symbol;
Number button 429: activates a sub-menu that comprises numbers 0 through 9 and arithmetic symbols such as the “+” symbol, “−” symbol, and “=” symbol; and
Punctuation button 431; activates a sub-menu that comprises various punctuation symbols.

In one embodiment, the selection of DSm buttons is similar to the selection of DS buttons. DSm buttons are selected by pressing and releasing the directional pad 201 in a direction that corresponds to the DSm button with respect to the current cursor location. However, responsive to selecting a DSm button, a sub-menu associated with the button is displayed to the driver. For example, from the default cursor portion, to select the number button 429, the driver presses and releases the up direction on the directional pad 201 of the steering wheel 107. Once the directional pad 201 is disengaged, the sub-menu displaying the characters associated with the menu is displayed to the driver.

### Keyboard Operation

As discussed previously, in one embodiment the cursor 300's default position is the center position of the main keyboard 400. When the keyboard 400 is first initiated, the cursor 300 is located at button 411B that corresponds to the center position of the keyboard 400. Furthermore, after a button is selected, the cursor returns to the default position on keyboard 400. By returning to the center portion of keyboard 400, memorization of the keyboard layout is simplified since each button may be reached from the center position of the keyboard 400 with only a small number of driver inputs at the steering wheel 107. That is, each button on keyboard 400 is reachable via a sequence of button presses from a relative position (e.g., the default position of the cursor 300).

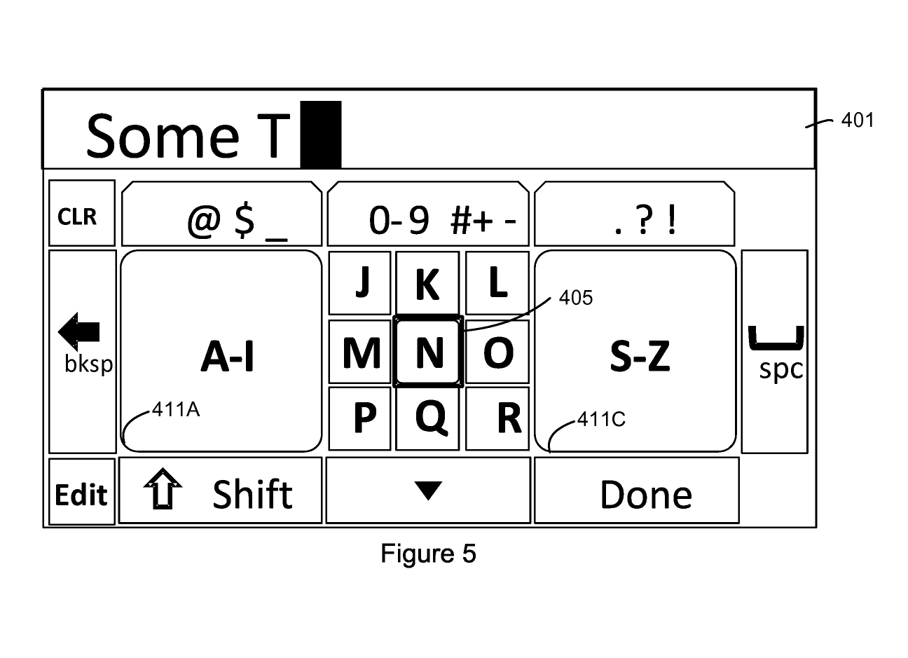

Responsive to the driver selecting a character set button 411 using the directional pad 201 and/or select button 205 on the steering wheel 107, the character set button 411 breaks apart into a plurality of DS buttons and a selectable button located at the center of the set. That is, responsive to the selection of a character set button 411, the driver is shown DS character buttons corresponding to the alphabet characters referenced by the character set button 411. The DS character buttons are displayed in the area of the keyboard 400 that the selected character set button 411 previously occupied. For example, responsive to the driver selecting character set button 411B using the select button 205 on the steering wheel 107, button 411B breaks apart into a plurality of DS buttons as shown in FIG. 5. In one embodiment, animation may be displayed illustrating the button 411B breaking apart. In other embodiments, the plurality of DS buttons shown in FIG. 5 is displayed in the area of the keyboard 400 that previously contained character set button 411B. The driver may also press the back button 207 on the steering wheel 107 to return to the previous state of the keyboard 400.

Because character set button 411B is associated with characters J through R, it breaks up into 8 DS character buttons and a single SS character button responsive to selection of the button 411B. Each character button corresponds to a character in the set of characters J through R. In one embodiment, the character buttons are arranged in alphabetical order as illustrated in FIG. 5. By arranging the characters in alphabetical order, the layout of the characters is conducive to memorization thereby allowing the driver to input text without viewing the keyboard 400 after enough practice.

After selection of a character set button 411, the cursor 300 is positioned at the center of the plurality of DS buttons associated with the selected character set button. That is, each character set button 411 comprises its default cursor position responsive to selection. In the example shown in FIG. 5, after selection of character set button 411B, cursor 300 is automatically positioned at character button “N.” Character button “N′ corresponds to the center of character set button 411B and is a SS button. Similarly, responsive to character set button 411A being selected, it breaks up into a plurality of DS buttons corresponding to characters A through I. In one embodiment, character “E” corresponds to the center of character set button 411A and is a SS button. Thus, the cursor 300 is automatically positioned over character “E” responsive to the selection of character set button 411A. Lastly, character set 411C also breaks up into a plurality of DS buttons corresponding to characters S through Z. In one embodiment, character “W” corresponds to the center of character set button 411C and is a SS button. Thus, the cursor 300 is automatically positioned over character “W” responsive to the selection of character set button 411C.

As mentioned previously, each character button is directional pad selectable. Thus, the driver of the vehicle 100 selects a letter from the set using only the directional pad on the steering wheel 107. Once a character set button 411 is selected, a letter may be selected with a single input at the steering wheel. For example, to select the “J” button, from the center position of the character set, the driver presses substantially simultaneously the up and left directions (i.e., the single input) on the directional pad 201. However, to select the character located at the center of the character selection button, the driver may use the select button 205 on the steering wheel to indicate the selection of the center character. For example, to select the “N” button, the driver presses the select button 205 the steering wheel 107.

Once a character is selected, the text field 401 is updated with the selected character. In one embodiment, responsive to the selection of a character, the speaker system 103 of the vehicle 100 also verbally confirms to the user the selected character. For example, responsive to the driver selecting the “R” button, the speaker system would produce an audio output corresponding to the pronunciation of the letter “R.” However, in alternate embodiments, the driver may disable the speaker system 103 from producing an audio output corresponding to a selected character.

Additionally, after a character is selected, the keyboard 400 returns to its previous state illustrated in FIG. 4 where the cursor 300 is located at its default position (e.g., positioned over character set button 411B). For example, responsive to selecting the “N” button, the keyboard 400 reverts back to its previous state shown in FIG. 4 where the cursor 300 is positioned over character set 411B.

Due to the text input method and character layout described herein, all characters may be inputted using no more than a series of 3 steering wheel character inputs (i.e., button presses on the controls of the steering wheel 107) as shown in the following table. In one embodiment, the series of steering wheel control inputs at the steering wheel 107 may comprise a combination of cursor movements (i.e., movement of cursor 300) using the directional pad 201 and keyboard button selections using buttons 203 on the steering wheel 107. Once a character set button 411 has been selected, the driver may select a letter using only a single steering wheel input. Note that the steering wheel control input combinations described below is referenced from the default position of the cursor 300.

| | Steering Wheel |
|---|---|
| Character | Control Inputs |
| A | [L], [Select], [UL] |
| B | [L], [Select], [U] |
| C | [L], [Select], [UR] |
| D | [L], [Select], [L] |
| E | [L], [Select], [Select] |
| F | [L], [Select], [R] |
| G | [L], [Select], [DL] |
| H | [L], [Select], [D] |
| I | [L], [Select], [DR] |
| J | [Select], [UL] |
| K | [Select], [U] |
| L | [Select], [UR] |
| M | [Select], [L] |
| N | [Select] |
| O | [Select], [R] |
| P | [Select], [DL] |
| Q | [Select], [D] |
| R | [Select], [DR] |
| S | [R], [Select], [UL] |
| T | [R], [Select], [U] |
| U | [R], [Select], [UR] |
| V | [R], [Select], [L] |
| W | [R], [Select], [Select] |
| X | [R], [Select], [UL] |
| Y | [R], [Select], [DL] |
| Z | [R], [Select], [D] |
| Clear | [L], [UL] |
| Space | [R], [R] |

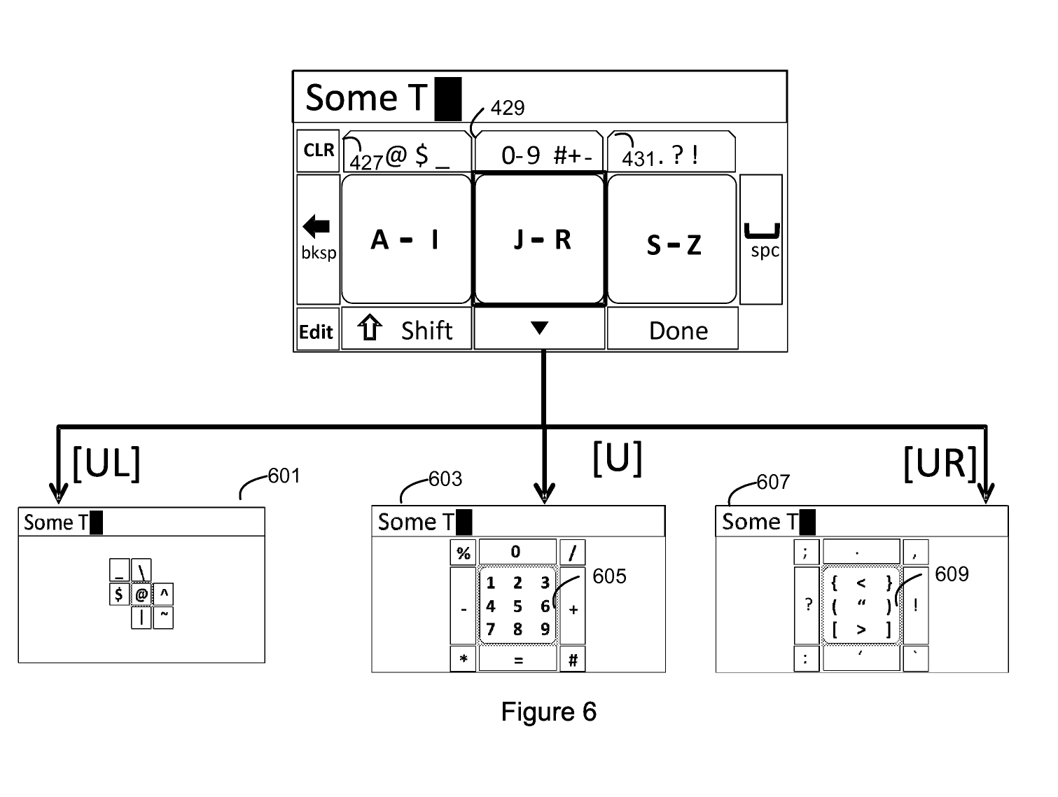

Referring now to FIG. 6, there is shown one embodiment of how to select symbols, numbers, and punctuations from their associated DSm buttons. To select other characters that are not shown on the main keyboard screen, the driver may select one of the three sub-menu keyboards by selecting the DSm buttons. As previously mentioned, DSm buttons are directional selectable buttons with a sub-menu. The keyboard 400 comprises three DSm buttons: symbol button 427, number button 429, and punctuation button 431.

To select the symbol button 427, from the default position of the cursor 300, the driver simultaneously presses the up and left directions of the directional pad 201 on the steering wheel 107. Selection of the symbol button 427 causes the display system 101 to display a symbol keyboard 601. The symbol keyboard 601 comprises a plurality of directional selectable (DS) symbol keys such as “_”, “\”, “$”, “̂”, “|”, and “˜”. The symbol keyboard 601 also comprises a SS button corresponding to the symbol “@” located at the center of symbol keyboard 601. Note that in other embodiments, the symbol keyboard 601 may comprise other symbols other than those illustrated in FIG. 6.

Responsive to selection of the symbol button 427, the cursor 300 is positioned at the center button of the symbol keyboard 601. Thus, the cursor 300 is positioned at the “@” symbol. Once a symbol is selected via the directional pad and/or select button 205, the main keyboard 400 shown in FIG. 4 is displayed to the driver with the cursor 300 located at its default position.

To select the number button 429, from the default position of cursor 300 on the main keyboard 400, the driver presses the up direction on the directional pad 201 of the steering wheel 107. Responsive to selection of the number button 429, the number keyboard 603 is displayed to the user. The number keyboard 603 comprises a number character set button 605 that is a SS button and corresponds to the default position for the number keyboard 603. Responsive to selection of the number character set button 605, it breaks up into a plurality of DS numeric buttons and a single SS button similar to the character set buttons described above. The numeric buttons are arranged in numerical order from 1 through 9. In one embodiment, the numeric button associated with “5” is the default position for the number character set button 605 and is a SS button.

In one embodiment, the number character set button 605 is surrounded by a plurality of DS buttons that correspond to arithmetic operations such as the “+” symbol, “−” symbol, “=” symbol, “*” symbol, “/” symbol, and “%” symbol. The plurality of DS buttons also includes a button for number “0”. Note that the arrangement of the arithmetic operations and zero buttons shown in FIG. 6 are only embodiment of the present invention and other arrangements may be used. Responsive to a selection of a button in the number keyboard 603, the main keyboard 400 shown in FIG. 4 is displayed to the driver with the cursor 300 located at its default position.

To select the punctuation button 431, from the default position of cursor 300, the driver simultaneously presses the up and right directions of the directional pad 201 on the steering wheel 107. Responsive to selection of the punctuation button 431, the punctuation keyboard 607 is displayed to the driver. In one embodiment, the punctuation keyboard 607 comprises a bracket character set button 609 that is the default position for cursor 300 on the punctuation keyboard 607.

Responsive to selection of the bracket character set button 609, it breaks apart into a plurality of DS buttons and a single SS button that correspond to bracket and punctuation symbols. The bracket and punctuation symbols may include the “{” symbol, “}” symbol, “(” symbol, “)” symbol, “[” symbol, “]”, “<”, “>” and “”” symbol. The “”” button is the SS button and may correspond to the default cursor position responsive to selection of the bracket character set button 609. In one embodiment, the bracket character set button 609 is surrounded by a plurality of DS buttons that correspond to various punctuation symbols such as the “;” symbol, “.” symbol, “,” symbol, “?” symbol, “!” symbol, “:”, “'” and “`” symbol. Note that the arrangement of the punctuation symbols shown in FIG. 6 are only embodiment of the present invention and other arrangements may be used. Responsive to a selection of a button in the punctuation keyboard 607, the main keyboard 400 shown in FIG. 4 is displayed to the driver with the cursor 300 located at its default position.

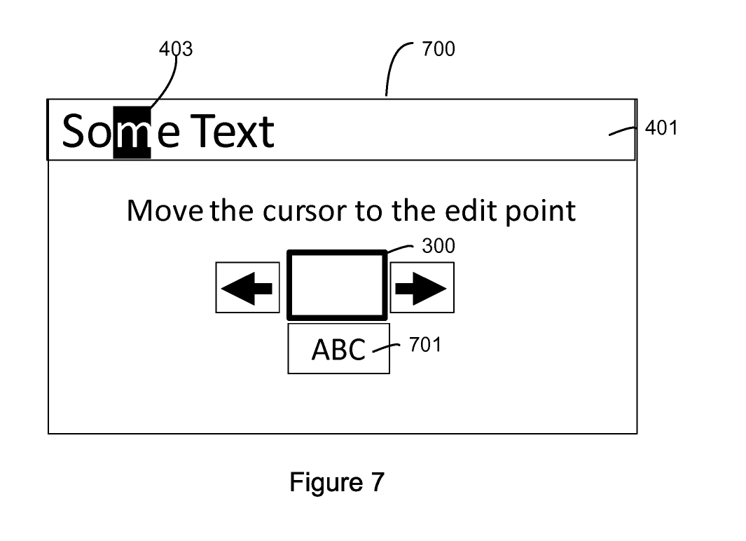

Referring back to FIG. 4, as described above, the edit button 415 allows the driver to edit text in the text field 401. Specifically, the edit button 415 allows the driver to move the text cursor 403 to some location in a string of text in order to change the insertion point of text. Referring to FIG. 7, there is shown a user interface used to edit text in text field 401.

In the example shown in FIG. 7, the driver may have previously inputted the text string “Some Text” into text field 401 and decided to edit the text string. Responsive to selecting the edit button 415 using the directional pad 201 and select button 205 on the steering wheel 107, the user interface 700 in FIG. 7 is displayed to the driver of the vehicle 100. The user interface 700 instructs the driver to move the text cursor 403 to the edit point using the directional pad 201. In this example, the driver moves the text cursor 403 to the left using the directional pad 201 on the steering wheel 107. When the driver reaches the desired edit point in the text string (e.g., the character “m”), the driver uses the directional pad 201 to move cursor 300 to the ABC button 701. Selection of the ABC button 701 causes the main keyboard 400 to return thereby allowing the driver to enter the desired text at the edit point.

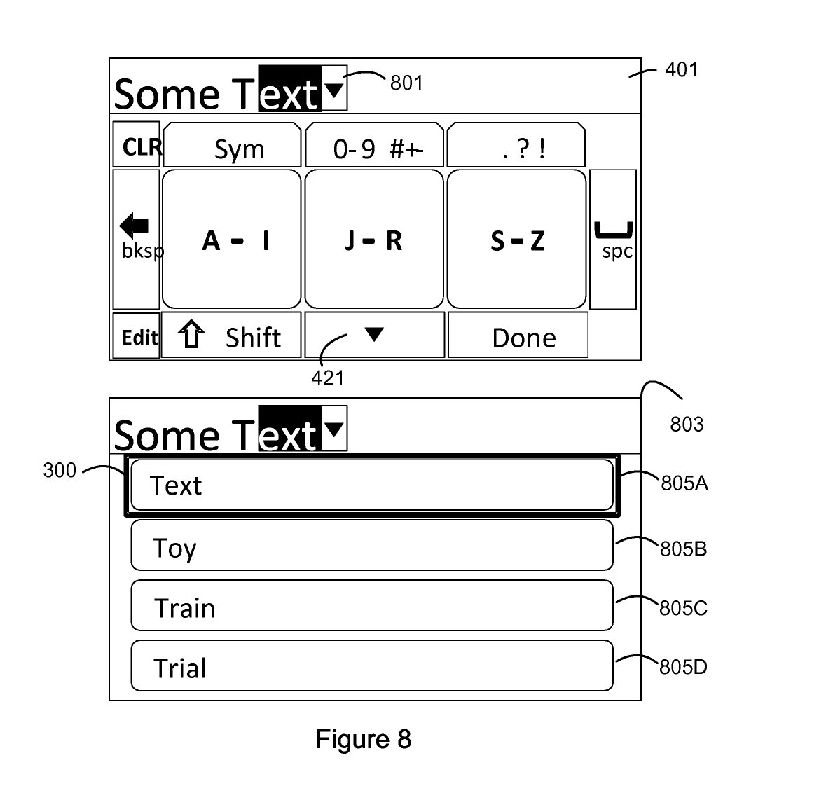

Referring back to FIG. 4, note that an incomplete word is currently in text field 401. The driver has inputted the character “T” but has not completed the word. Referring now to FIG. 8, in one embodiment the driver is provided with an automatic suggestion 801 to complete the text. The automatic suggestion 801 is indicated by the highlighted text. The driver may browse through suggested text stored in memory to complete the word by pressing the down direction on the directional pad 201 of the steering wheel 107 to select the down arrow button 421. Responsive to selection of the down arrow button 421, the suggested text user interface 803 is displayed to the driver.

User interface 803 comprises one or more suggested text 805 to complete the incomplete text in text field 401. Note that the suggested texts are SS buttons and require use of the directional pad 201 and select button 205 to make a selection. The driver may browse through the suggested text 805 to select a word to complete the text in text field 401. Once the driver identifies the correct word to complete the text, the directional pad 201 is used to move the cursor 300 to the appropriate text 805 and selects the text using the select button 205 on the steering wheel 107. For example, to select the button associated with the button “Text” 805A the driver presses the select button 205. However, to select the button “Toy” 805B, the driver presses the down direction on the directional pad 201 to move the cursor to the button 805B and presses the select button 205. Once the suggested text is selected, the word in the text field 401 is completed with the selected suggested text and the main keyboard 400 is displayed to the driver. However, if none of the suggested text accurately completes the text in text field 401, the driver may press the back button 207 on the steering wheel to return back to the main keyboard 400. In one embodiment, responsive to the driver moving the cursor 300 to the appropriate text suggestion 805, the speaker system 103 outputs the word associated with the text 805 to the driver of the vehicle. For example, responsive to the driver moving the cursor 300 to the button 805A, the audio cue corresponding to the word “Text” is outputted by the speaker system 103.

### Text Entry Method

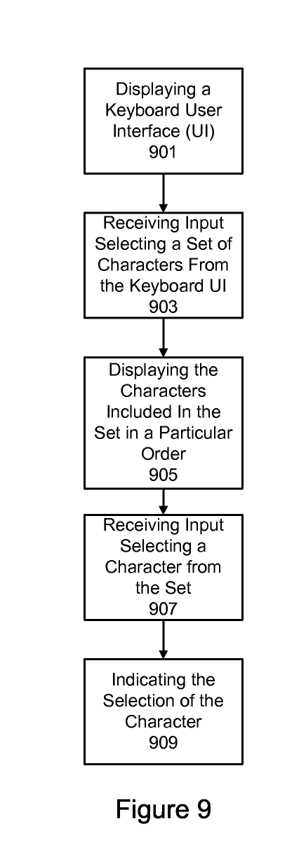

Referring now to FIG. 9, there is shown one embodiment for in-vehicle text input via the steering wheel of the vehicle. Note that in other embodiments, other steps may be performed than those illustrated in FIG. 9.

In one embodiment, the in-vehicle text input system displays 901 to the driver of a vehicle a keyboard user interface (UI). The keyboard may be displayed in a display system of the vehicle. The system receives 903 one or more steering wheel character inputs selecting a set of characters from the keyboard UI. For example, the system may receive from the driver a selection of a character set button corresponding to characters A through I. The driver may use the directional pad 201 and select button 205 on the steering wheel 107 of the vehicle to select the character set button. The system displays 905 the characters included in the selected set in the area of the keyboard that previously contained the character set button. The characters included in the selected set are displayed to the driver in a particular order. For example, responsive to the driver selecting the character set button corresponding to characters A through I, the characters are displayed to the driver in alphabetical order.

The system then receives 907 a steering wheel character input selecting a character from the set. The driver uses the directional pad to select a particular character from characters A through I in this example. Responsive to the selection of a character, the system indicates 909 to the driver the selection of the character. In one embodiment, the system visually indicates to the driver the selection of the character by updating a displayed text field with the selected character. Additionally, the system may also provide an audio cue indicating the selection of the character. For example, if the driver selected the letter “A”, the system would output audio reading the letter “A.”

### Blind Text Input

As discussed above, the advantage of the keyboard layout shown in FIG. 4 used in vehicle applications is that it is conducive to memorization. With enough practice, the driver of the vehicle may learn the button press combinations needed to input a specific character. Thus, the driver may input the correct sequence of button combinations to type the directed characters without having to look at the display screen. Such skill is useful because anti-distraction laws may prohibit a full keyboard, such as keyboard 400, from being displayed on the display screen of a vehicle while the vehicle is moving.

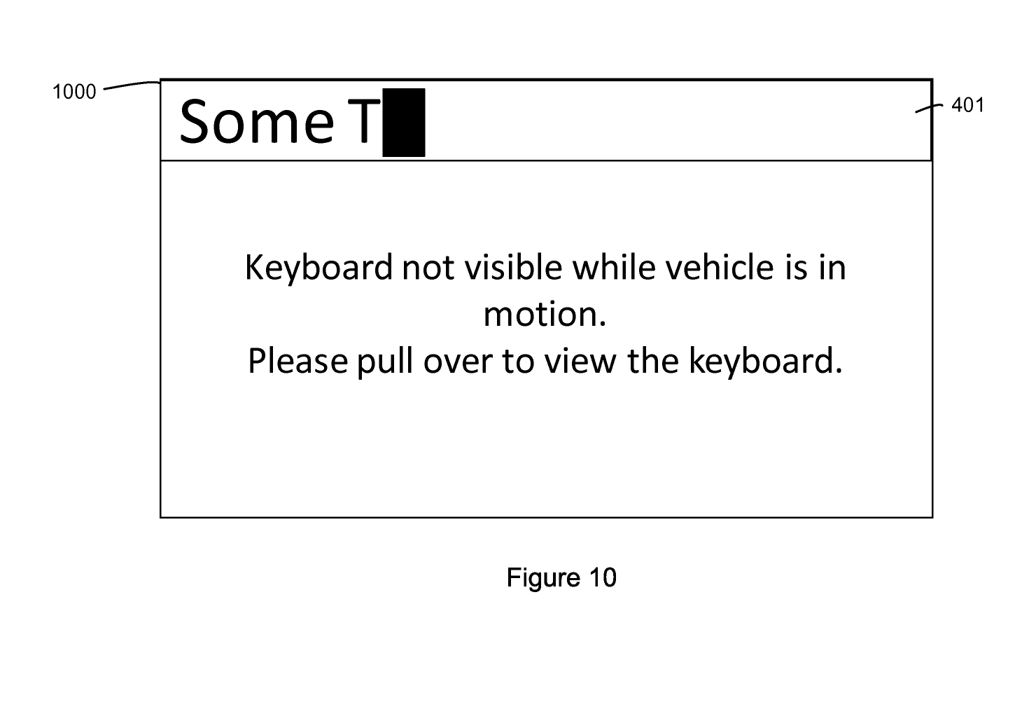

For example, referring now to FIG. 10, the user interface 1000 displayed to the driver indicates that the keyboard will not be visible while the vehicle is in motion. The user interface 1000 indicates that the driver must pull over to view the keyboard. However, the text field 401 may still be displayed to the driver of the vehicle and text input functionality may still be enabled. Thus, the driver may still perform text input given that the driver presses the correct series of buttons on the steering wheel. Furthermore, the method of typing described above combined with various audio cues, such as reading the typed character, may allow the driver to input a string of text without the need to look at the display screen. Note that in other embodiments, the keyboard may still be displayed to the driver regardless if the vehicle is moving.

### Alternative Keyboard Layout

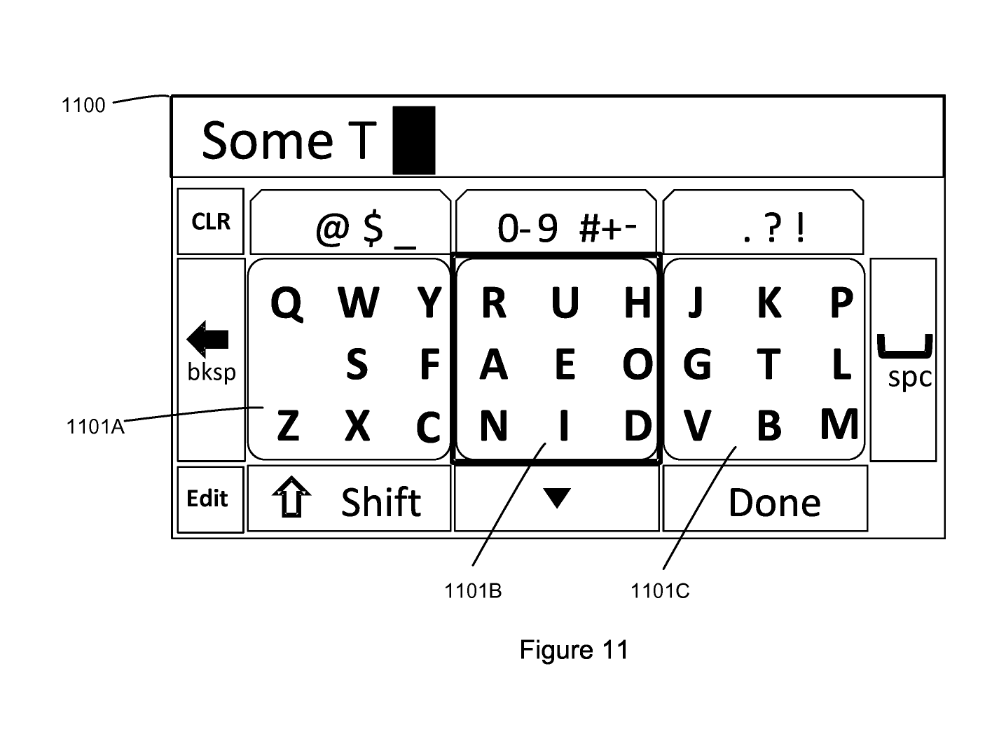

Referring now to FIG. 11, there is shown an alternative embodiment of the layout for the main keyboard 1100. The keyboard 1100 shown in FIG. 11 is similar to the keyboard shown in FIG. 4. The functionality of the buttons in keyboard 1100 is similar to the buttons in keyboard 400 and thus will be omitted for brevity purposes.

However, in keyboard 1100 for each character set buttons 1101, the associated characters are not arranged in alphabetical order as is shown in keyboard 400. Rather, the character set buttons 1101 are arranged such that all high frequency keys are located in character set button 1101B. Note that all the vowels are included in character set button 1101B as well as other frequently used characters. In one embodiment, character set buttons 1101A and 1101C respectively include frequently used characters “S” and “T” located at the center of each button. The characters surrounding the frequently used characters in buttons 1101A and 1101C represent characters that are not as frequently used in the English language.

Referring back to FIG. 4, in an alternative embodiment of keyboard 400, each character set button 411 comprises an alternative arrangement of letters other than the arrangement illustrated in FIG. 4. For example, character set button 411A may comprise letters A through H rather than A through I. Accordingly, character set button 411B may comprise letters I through Q and character set button 411C may comprise letters R through Z. Any other letter arrangement may be used in character set buttons 411 such that the letters are displayed in an alphabetical order. Furthermore, additional character set buttons may be used rather than the amount illustrated in FIG. 4. In alternative embodiments, fewer character set buttons may be used rather than the number of character set buttons show in FIG. 4.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

What is claimed is:

1. A computer-implemented method for inputting text in a vehicle using controls of a steering wheel of the vehicle, the method comprising:
displaying to a driver of the vehicle a keyboard user interface comprising three or more character set user interface elements, each character set user interface element associated with a distinct set of alphabetical letters;
responsive to receiving from the driver one or more steering wheel character inputs to select a character set user interface element, displaying a set of alphabetical letters associated with the selected character set user interface element in an arranged order, wherein each alphabetical letter in the set is selectable responsive to either one or two steering wheel character inputs;
receiving, via the steering wheel, the one or two steering wheel character inputs selecting an alphabetical letter from the set of alphabetical letters; and
indicating to the driver the selection of the alphabetical letter.

2. The computer-implemented method of claim 1, wherein the character set user interface elements is displayed on the keyboard using a first visual appearance.

3. The computer-implemented method of claim 1, wherein the controls of the steering wheel comprise a directional pad for controlling a keyboard cursor displayed on the keyboard and a selection button for selecting one of the character set user interface elements.

4. The computer-implemented method of claim 3, wherein the keyboard further comprises sub-menu user interface elements that are displayed on the keyboard in a second visual appearance, each sub-menu user interface element being selected responsive to the keyboard cursor being positioned on the sub-menu user interface element, the sub-menu user interface elements comprising:
a symbol sub-menu user interface element including a plurality of symbols;
a number sub-menu user interface element including a plurality of numbers; and
a punctuation sub-menu user interface element including punctuation characters.

5. The computer-implemented method of claim 3, wherein the keyboard further comprises keyboard action user interface elements displayed in a third visual appearance on the keyboard, each keyboard action user interface element being selected responsive to the keyboard cursor being positioned on the keyboard action user interface element, the keyboard action user interface elements comprising:
a clear user interface element that causes text within a text field of the keyboard to be cleared;
a backspace user interface element that deletes a character within the text field;
an edit user interface element to edit text within the text field;
a shift user interface element to enter an uppercase alphabetical character in the text field;
a down arrow user interface element to request auto-suggestions to complete text in the text field; and
a space user interface element to add a space between text in the text field.

6. The computer-implemented method of claim 3, wherein displaying to the driver the set of alphabetical letters associated with the selected character set user interface element comprises:
receiving one or more steering wheel character inputs positioning the keyboard cursor on the character set user interface element using the directional pad, the one or more steering wheel character inputs further selecting the character set user interface element using the select button;
responsive to the selection of the character set user interface element, displaying in an area of the keyboard that comprises the selected character set user interface element, a plurality of alphabetical letter user interface elements associated with the selected character set user interface element; and
responsive to displaying the plurality of alphabetical user interface elements, automatically positioning the keyboard cursor at a default position located at a center of the plurality of alphabetical letter user interface elements.

7. The computer-implemented method of claim 6, wherein receiving, via the steering wheel, the one or two steering wheel character inputs selecting the alphabetical letter from the set of alphabetical letters comprises:
receiving the one or two steering wheel character input using the directional pad to position the keyboard cursor on the alphabetical user interface element; and
responsive to the keyboard cursor being positioned on the alphabetical user interface element, automatically selecting the alphabetical letter.

8. The computer-implemented method of claim 2, wherein the keyboard cursor is by default positioned at one of the character set user interface elements.

9. The computer-implemented method of claim 1, wherein indicating to the driver the selection of the alphabetical character comprises:
displaying the selected alphabetical character in a text field of the keyboard; and
outputting an audio cue corresponding to the selected alphabetical character substantially simultaneously with the display of the selected alphabetical character.

10. The computer-implemented method of claim 1, wherein displaying a set of alphabetical letters associated with the selected character set user interface element in an arranged order comprises:
displaying the set of alphabetical letters in alphabetical order.

11. A non-transitory computer-readable storage medium storing executable code for inputting text in a vehicle using controls of a steering wheel of the vehicle, the code when executed performs the steps of:
displaying to a driver of the vehicle a keyboard user interface comprising three or more character set user interface elements, each character set user interface element associated with a distinct set of alphabetical letters;
responsive to receiving from the driver one or more steering wheel character inputs to select a character set user interface element, displaying a set of alphabetical letters associated with the selected character set user interface element in an arranged order, wherein each alphabetical letter in the set is selectable responsive to one or two steering wheel character input;
receiving, via the steering wheel, the one or two steering wheel character inputs selecting an alphabetical letter from the set of alphabetical letters; and
indicating to the driver the selection of the alphabetical letter.

12. The non-transitory computer-readable storage medium of claim 11, wherein the character set user interface elements is displayed on the keyboard using a first visual appearance.

13. The non-transitory computer-readable storage medium of claim 11, wherein the keyboard further comprises sub-menu user interface elements that are displayed in a second visual appearance on the keyboard, each sub-menu user interface element being selected responsive to a keyboard cursor being positioned on the sub-menu user interface element, the sub-menu user interface elements comprising:
a symbol sub-menu user interface element including a plurality of symbols;
a number sub-menu user interface element including a plurality of numbers; and
a punctuation sub-menu user interface element including punctuation characters.

14. The non-transitory computer-readable storage medium of claim 11, wherein the keyboard further comprises keyboard action user interface elements displayed in a third visual appearance on the keyboard, each keyboard action user interface element being selected responsive to a keyboard cursor being positioned on the keyboard action user interface element, the keyboard action user interface elements comprising:
a clear user interface element that causes text within a text field of the keyboard to be cleared;
a backspace user interface element that deletes a character within the text field;
an edit user interface element to edit text within the text field;
a shift user interface element to enter an uppercase alphabetical character in the text field;
a down arrow user interface element to request auto-suggestions to complete text in the text field; and
a space user interface element to add a space between text in the text field.

15. The non-transitory computer-readable storage medium of claim 11, wherein indicating to the driver the selection of the alphabetical character comprises:
displaying the selected alphabetical character in a text field of the keyboard; and
outputting an audio cue corresponding to the selected alphabetical character substantially simultaneously with the display of the selected alphabetical character.

16. A vehicle system for inputting text, the system comprising:
a steering wheel including controls for inputting text;
a display system for displaying text;
a computer processor; and
a non-transitory computer-readable storage medium storing executable code, the code when executed by the computer processor performs the steps comprising:
using the display system to display to a driver of the vehicle a keyboard user interface comprising three or more character set user interface elements, each character set user interface element associated with a distinct set of alphabetical letters;
responsive to receiving one or more steering wheel character inputs selecting a character set user interface element, using the display system to display a set of alphabetical letters associated with the selected character set user interface element in an arranged order, wherein each alphabetical letter in the set is selectable responsive to one or two steering wheel character inputs;
receiving, via the steering wheel, the one or two steering wheel character inputs selecting an alphabetical letter from the set of alphabetical letters; and
indicating to the driver the selection of the alphabetical letter.

17. The vehicle system of claim 16, wherein the character set user interface elements is displayed using a first visual appearance on the keyboard.

18. The vehicle system of claim 16, wherein the keyboard further comprises sub-menu user interface elements that are displayed in a second visual appearance on the keyboard, each sub-menu user interface element being selected responsive to a keyboard cursor being positioned on the sub-menu user interface element, the sub-menu user interface elements comprising:
a symbol sub-menu user interface element including a plurality of symbols;
a number sub-menu user interface element including a plurality of numbers; and
a punctuation sub-menu user interface element including punctuation characters.

19. The vehicle system of claim 16, wherein the keyboard further comprises keyboard action user interface elements displayed in a third visual appearance on the keyboard, each keyboard action user interface element being selected responsive to a keyboard cursor being positioned on the keyboard action user interface element, the keyboard action user interface elements comprising:
a clear user interface element that causes text within a text field of the keyboard to be cleared;
a backspace user interface element that deletes a character within the text field;
an edit user interface element to edit text within the text field;
a shift user interface element to enter an uppercase alphabetical character in the text field;
a down arrow user interface element to request auto-suggestions to complete text in the text field; and
a space user interface element to add a space between text in the text field.

20. The vehicle system of claim 16, further comprising an audio system and wherein indicating to the driver the selection of the alphabetical character comprises:
using the display system to display the selected alphabetical character in a text field of the keyboard; and
using the audio system to output an audio cue corresponding to the selected alphabetical character substantially simultaneously with the display of the selected alphabetical character.
